(19) United States
(12) Patent Application Publication
(10) Pub. No.: US 2021/0225207 A1
(43) Pub. Date: Jul. 22, 2021

(54) DISPLAY DEVICE, DISPLAY METHOD, AND DISPLAY PROGRAM

(71) Applicant: Sharp NEC Display Solutions, Ltd., Tokyo (JP)

(72) Inventor: Toshiya HAMANO, Tokyo (JP)

(21) Appl. No.: 17/222,908

(22) Filed: Apr. 5, 2021

Related U.S. Application Data
(63) Continuation of application No. PCT/JP2018/040174, filed on Oct. 29, 2018.

(51) Int. Cl. G09F 9/30; G06F 3/14; G06Q 30/02; G01K 1/02; G01K 3/10

(52) U.S. Cl. CPC G09F 9/30; G06F 3/14; G01K 3/10; G01K 1/02; G06Q 30/0252

(57) ABSTRACT

A display device includes a display unit, a storage unit configured to store display-related information in which an air temperature condition for displaying display information to be displayed on the display unit and related to an air temperature difference from a previous day, is associated with the display information, and air temperature information in which a date and time are associated with an air temperature on the date and time, and a display processing unit configured to determine the display information to be displayed on the display unit on the basis of the air temperature difference, obtained on the basis of first air temperature information that is the air temperature information on a day when the display unit displays the display information and second air temperature information that is the air temperature information on a previous day of the day, and the display-related information, and cause the display unit to display the determined display information.

### TECHNICAL FIELD

The present invention relates to a display device, a display method, and a display program.

### BACKGROUND ART

In recent years, a system that acquires air temperature information at a time of display of an advertisement and displays the advertisement on the basis of the air temperature information has become known (for example, refer to Patent Literature 1).

### CITATION LIST

### Patent Literature

### [Patent Literature 1]

Japanese Unexamined Patent Application, First Publication No. 2002-215656

### SUMMARY OF INVENTION

### Technical Problem

However, in the conventional technology, for example, when an advertisement for a product to sell in a store or the like is displayed, an out-of-season product that is totally different from a product displayed in the advertisement based on the air temperature of the corresponding day may suddenly be sold. This is because a temperature difference from a previous day is large, and a purchaser purchases a product on the basis of the temperature difference from the previous day. In this case, there is a problem that an advertisement for a product that a purchaser wants to purchase cannot be shown in Patent Literature 1.

The present invention has been made to solve the problem described above, and an object thereof is to provide a display device, a display method, and a display program that can easily present information according to a temperature difference.

### Solution to Problem

The present invention has been made to solve the problems described above, and according to one aspect of the present invention, there is a display device that includes a display unit, a storage unit configured to store display-related information in which an air temperature condition, which is a condition for displaying display information to be displayed on the display unit and is a condition related to an air temperature difference from a previous day, is associated with the display information, and air temperature information in which a date and time are associated with an air temperature on the date and time, and a display processing unit configured to determine the display information to be displayed on the display unit on the basis of the air temperature difference obtained on the basis of first air temperature information that is the air temperature information on a day when the display unit displays the display information and second air temperature information that is the air temperature information on a previous day of the day, and the display-related information, and cause the display unit to display the determined display information.

In addition, according to another aspect of the present invention, a display method of a display device that includes a display unit, and a storage unit configured to store display-related information in which an air temperature condition, which is a condition for displaying display information to be displayed on the display unit and is a condition related to an air temperature difference from a previous day, is associated with the display information, and air temperature information in which a date and time are associated with an air temperature on the date and time is a display method that includes determining, by a display processing unit, the display information to be displayed on the display unit on the basis of the air temperature difference obtained on the basis of first air temperature information that is the air temperature information on a day when the display unit displays the display information and second air temperature information that is the air temperature information on a previous day of the day, and the display-related information, and causing the display unit to display the determined display information.

Moreover, according to still another aspect of the present invention, a display program causes a computer of a display device, which includes a display unit, a storage unit configured to store display-related information in which an air temperature condition, which is a condition for displaying display information to be displayed on the display unit and is a condition related to an air temperature difference from a previous day, is associated with the display information, and air temperature information in which a date and time are associated with an air temperature on the date and time, to execute processing of determining the display information to be displayed on the display unit on the basis of the air temperature difference, obtained on the basis of first air temperature information that is the air temperature information on a day when the display unit displays the display information and second air temperature information that is the air temperature information on a previous day of the day, and the display-related information, and causing the display unit to display the determined display information.

### Advantageous Effects of Invention

According to the present invention, information according to a temperature difference can be easily presented.

### BRIEF DESCRIPTION OF DRAWINGS

FIG. 1 is a block diagram which shows an example of a display device 1 according to a first embodiment.

FIG. 2 is a block diagram which shows an example of a display device 1a according to a second embodiment.

FIG. 3 is a diagram which shows an example of air temperature information of an air temperature information storage unit 121 according to the present embodiment.

FIG. 4 is a diagram which shows an example of display-related information of a display-related information storage unit 122 according to the present embodiment.

FIG. 5 is a flowchart which shows an example of processing of the display device 1a according to the present embodiment.

FIG. 6 is a block diagram which shows an example of a display device 1b according to a third embodiment.

FIG. 7 is a diagram which shows an example of air temperature information of an air temperature information storage unit 121b according to the present embodiment.

FIG. 8 is a diagram which shows an example of display-related information of a display-related information storage unit 122b according to the present embodiment.

FIG. 9 is a flowchart which shows an example of processing of the display device 1b according to the present embodiment.

FIG. 10 is a diagram which shows another example of the display-related information storage unit 122b according to the present embodiment.

### DESCRIPTION OF EMBODIMENTS

Hereinafter, a display device and a display method according to embodiments of the present invention will be described with reference to the drawings.

### First Embodiment

First, a first embodiment of the present invention will be described with reference to the drawings.

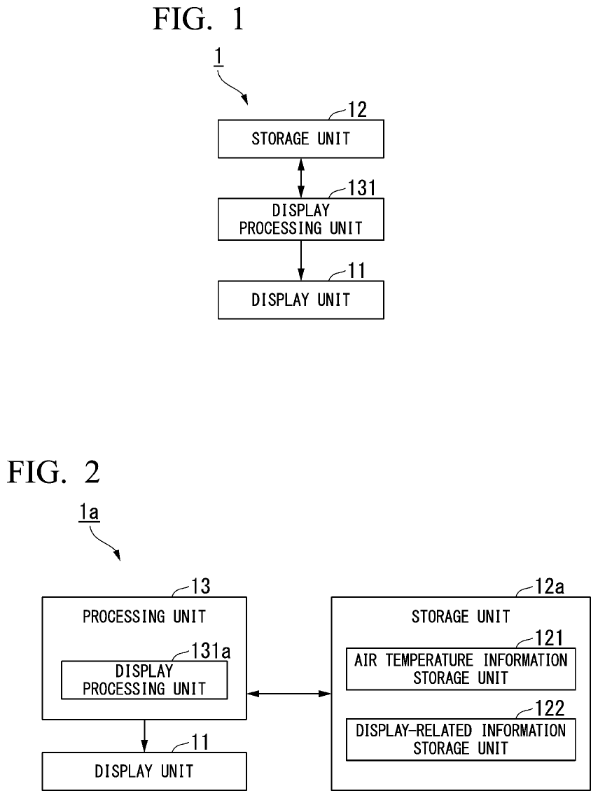

FIG. 1 is a block diagram which shows an example of a display device 1 according to the first embodiment.

The display device 1 includes a display unit 11, a storage unit 12 that stores display-related information in which an air temperature condition, which is a condition for displaying display information displayed by the display unit 11 and is a condition related to an air temperature difference from a previous day, is associated with the display information, and air temperature information in which a date and time are associated with an air temperature on the date and time, and a display processing unit 131 that determines the display information to be displayed on the display unit on the basis of the air temperature difference obtained on the basis of first air temperature information that is the air temperature information on a day when the display unit 11 displays the display information and second air temperature information that is the air temperature information on a previous day of the day, and the display-related information, and causes the display unit 11 to display the determined display information.

As a result, when a temperature difference occurs, the display device 1 according to the present embodiment can easily display information according to the temperature difference.

### Second Embodiment

Next, a second embodiment of the present invention will be described with reference to the drawings.

In the present embodiment, a modified example in which a storage unit 12a includes an air temperature information storage unit 121 that stores air temperature information and a display-related information storage unit 122 that stores display-related information will be described.

FIG. 2 is a block diagram which shows an example of a display device 1a according to a second embodiment. The display device 1a includes the display unit 11, the storage unit 12a, and the processing unit 13. In FIG. 2, the same constituents as in FIG. 1 described above will be denoted by the same reference numerals, and the description thereof will be omitted.

The display unit 11 is configured to include a display device. The display device is, for example, an organic electroluminescence display (OLED), a plasma display, a liquid crystal display (LCD), or the like. The display unit 11 displays various types of information input from the processing unit 13.

The storage unit 12a includes, for example, a hard disk drive (an HDD), a flash memory, an electrically erasable programmable read only memory (an EEPROM), a read only memory (an ROM), a random access memory (a RAM), or the like, and stores various programs to be executed by a CPU included in the display device 1 such as firmware and application programs, results of processing executed by the CPU, and the like. The processing unit 13 functions, for example, when the CPU included in the display device 1 executes a program stored in the storage unit 12a.

The storage unit 12a includes an air temperature information storage unit 121 and a display-related information storage unit 122.

The air temperature information storage unit 121 stores air temperature information in which a date and time and an air temperature at a time of the date and time are associated with each other. The air temperature information storage unit 121 stores air temperature information, for example, as shown in FIG. 2.

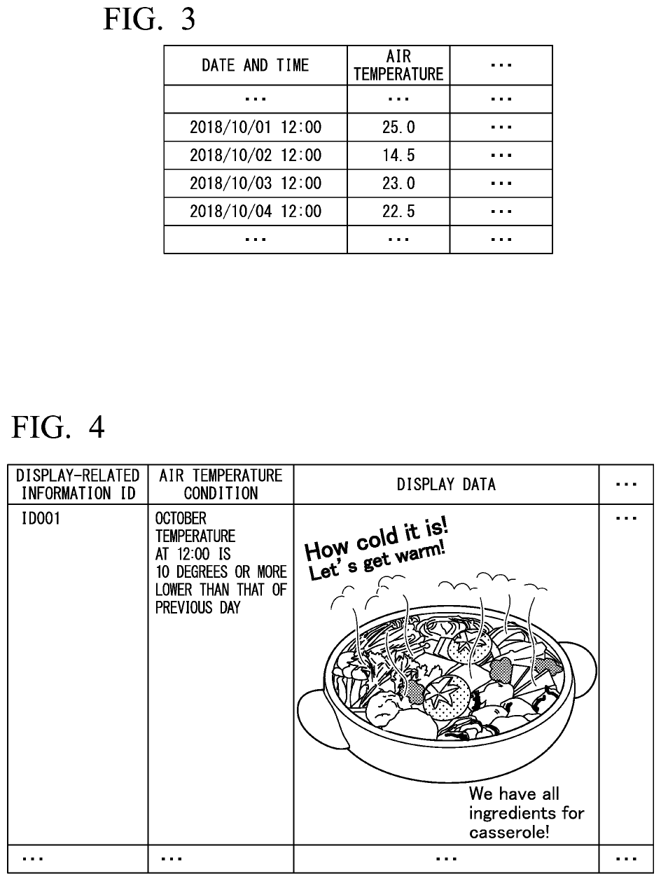

FIG. 3 is a diagram which shows an example of air temperature information stored by the air temperature information storage unit 121. The air temperature information storage unit 121 stores “date and time” and “air temperature” in association with each other. “Date and time” is a date and time when an air temperature is measured. “Air temperature” is an air temperature at a date and time indicated in “date and time.” In the example of FIG. 3, for example, an air temperature of “25.0” degrees is associated as an “air temperature” corresponding to a date and time of “2018/10/01 12:00” in the “date and time.”

The display-related information storage unit 122 stores display-related information in which display information to be displayed on the display unit 11 is associated with an air temperature condition that is a condition related to an air temperature difference from a previous day for displaying the display information. The display information is, for example, an image, a video, or the like to be displayed on the display unit 11. The air temperature condition includes, for example, a date and time condition for obtaining an air temperature difference and an air temperature difference condition. The display-related information storage unit 122 stores, for example, display-related information as shown in FIG. 4.

FIG. 4 is a diagram which shows an example of display-related information stored by the display-related information storage unit 122. The display-related information storage unit 122 stores a “display-related information ID,” an “air temperature condition,” and “display data” in association with each other. The “display-related information ID” is identification information for identifying display-related information. The “air temperature condition” indicates a condition related to an air temperature difference for displaying the display information. The “display data” is information (an example of the display information) such as an image or a video to be displayed on the display unit 11. In addition, the “display data” is, for example, information that is intended to be shown to a viewer of the display device 1 when an “air temperature condition” is satisfied.

In the example shown in FIG. 4, for example, an “air temperature condition” corresponding to the “display-related information ID” of “ID001” is “October” and “a temperature at 12:00 is lower than that of the previous day by 10 degrees or more,” and “display data” indicates that it is a “video recommending a pot.”

The processing unit 13 is a processor that includes a central processing unit (CPU) and the like, and performs overall control processing of the display device 1. The processing unit 13 performs, for example, processing related to information to be displayed on the display unit 11. Moreover, the processing unit 13 causes the display unit 11 to display the display information. The processing unit 13 includes a display processing unit 131a.

The display processing unit 131a performs display processing of determining display information on the basis of air temperature information and display-related information, and causing the display unit 11 to display the display information. The display processing unit 131a reads an air temperature condition from the display-related information storage unit 122. The display processing unit 131a acquires information required to obtain an air temperature difference on the basis of air temperature information. The display processing unit 131a refers to the air temperature information storage unit 121, acquires the air temperature information on the basis of the information required to obtain the air temperature difference, and obtains the air temperature difference. When the obtained air temperature difference satisfies the air temperature condition of the display-related information, the display processing unit 131a determines the display information of the display-related information as display information to be displayed on the display unit 11. The display processing unit 131a causes the display unit 11 to display the determined display information.

Next, an operation of the display device 1a according to the present embodiment will be described with reference to the drawings.

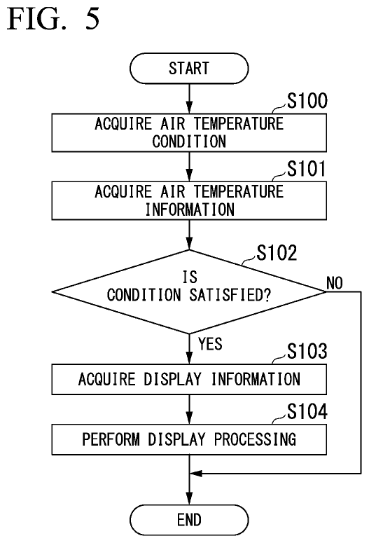

FIG. 5 is a flowchart which shows an example of processing of the display device 1a according to the present embodiment.

(Step S100) The display processing unit 131a of the processing unit 13 reads display-related information from the display-related information storage unit 122. The display processing unit 131a refers to the display-related information and acquires an air temperature condition. The display processing unit 131a acquires a date and time condition for obtaining an air temperature difference among conditions included in the air temperature condition. The display processing unit 131a acquires date and time information, and determines whether the acquisition date and time information satisfies the date and time condition for obtaining an air temperature difference. When the acquisition date and time information satisfies the date and time condition for obtaining an air temperature difference, the display processing unit 131a determines that the date and time condition for obtaining an air temperature difference is satisfied, and acquires conditions required to determine an air temperature difference condition. If the date and time condition for obtaining an air temperature difference is not satisfied, the display processing unit 131a determines that the date and time condition for obtaining the air temperature difference is not satisfied, and repeats the processing described above for other display-related information. The display processing unit 131a acquires the condition required to determine an air temperature difference condition and the processing proceeds to step S101.

If the air temperature condition does not have a date and time condition for obtaining the air temperature difference, the display processing unit 131a does not perform the process of determining whether or not the above conditions are satisfied.

(Step S101) The display processing unit 131a acquires air temperature information from the air temperature information storage unit 121 on the basis of the condition required to determine an air temperature difference condition. For example, since air temperature information at 12 o'clock of the day and the previous day is required in the case of a condition that “an air temperature difference from the previous day at 12 o'clock is +5 degrees or more,” the display processing unit 131a acquires the air temperature information at 12 o'clock on the day and the previous day from the air temperature information storage unit 121. If the display processing unit 131a acquires the air temperature information, the processing proceeds to step S102.

(Step S102) The display processing unit 131a obtains an air temperature difference on the basis of the acquired air temperature information. The display processing unit 131a determines whether the obtained air temperature difference satisfies an air temperature difference condition. If the obtained air temperature difference does not satisfy the air temperature difference condition, the display processing unit 131a determines that the air temperature difference condition is not satisfied (step S102: NO), and ends the processing. When the obtained air temperature difference satisfies the air temperature difference condition, the display processing unit 131a determines that the air temperature difference condition is satisfied (step S102: YES), and the processing proceeds to step S103.

(Step S103) The display processing unit 131a refers to display-related information, and acquires display information of the display-related information that satisfies an air temperature condition, and the processing proceeds to step S104.

(Step S104) The display processing unit 131a causes the display unit 11 to display the acquired display information and ends display processing.

As described above, the display device 1a according to the present embodiment includes the display unit 11, the storage unit 12a that stores display-related information in which an air temperature condition, which is a condition for displaying display information to be displayed on the display unit 11 and is a condition related to an air temperature difference from a previous day, is associated with the display information, and air temperature information in which a date and time are associated with an air temperature on the date and time, and a display processing unit 131a that determines the display information to be displayed on the display unit 11a on the basis of the air temperature difference, obtained on the basis of first air temperature information that is the air temperature information on a day when the display unit 11a displays the display information and second air temperature information that is the air temperature information on a previous day of the day, and the display-related information, and causes the display unit to display the determined display information.

As a result, the display device 1a according to the present embodiment stores in advance information to be displayed when a certain temperature difference occurs, thereby easily displaying the information to be displayed on the display unit 11 when the temperature difference actually occurs. For this reason, the display device 1 according to the present embodiment can easily present information according to the temperature difference.

### Third Embodiment

Next, a third embodiment of the present invention will be described with reference to the drawings.

In the present embodiment, a modified example when a temperature detection unit is included and air temperature information is acquired on the basis of a temperature detected by the temperature detection unit will be described.

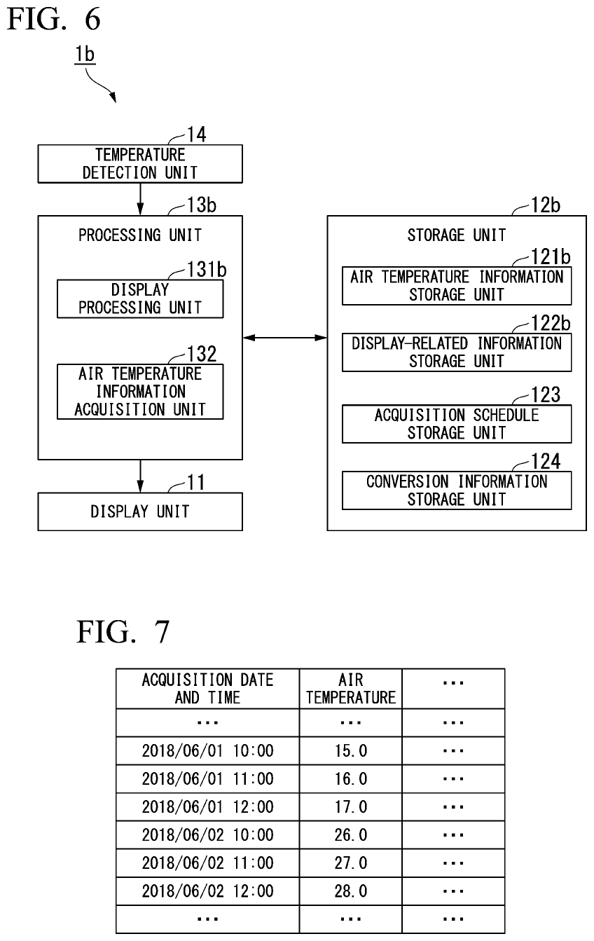

FIG. 6 is a block diagram which shows an example of a display device 1b according to a third embodiment. The display device 1b includes the display unit 11, a storage unit 12b, and a processing unit 13b. In FIG. 6, the same constituents as in FIGS. 1 and 2 described above will be denoted by the same reference numerals, and the description thereof will be omitted.

The storage unit 12b includes an air temperature information storage unit 121b, a display-related information storage unit 122b, an acquisition schedule storage unit 123, and a conversion information storage unit 124. Basic functions of the storage unit 12b are the same as those of the storage unit 12a.

The air temperature information storage unit 121b stores air temperature information in which an air temperature acquired by an air temperature information acquisition unit 132 to be described below is associated with information on an acquisition date and time. The air temperature information storage unit 121b stores, for example, air temperature information as shown in FIG. 7.

FIG. 7 is a diagram which shows an example of air temperature information stored by the air temperature information storage unit 121b. The air temperature information storage unit 121b stores “acquisition date and time” and “air temperature” in association with each other. The “acquisition date and time” are a date and time when the air temperature information acquisition unit 132 acquires a temperature from the temperature detection unit 14. The “air temperature” is an air temperature obtained by converting the temperature acquired from the temperature detection unit 14 by the air temperature information acquisition unit 132. The processing of the air temperature information acquisition unit 132 will be described below.

In the example of FIG. 7, for example, an air temperature of “15.0” degrees is associated as an “air temperature” corresponding to a date and time of “2018/06/01 10:00” in the “acquisition date and time.”

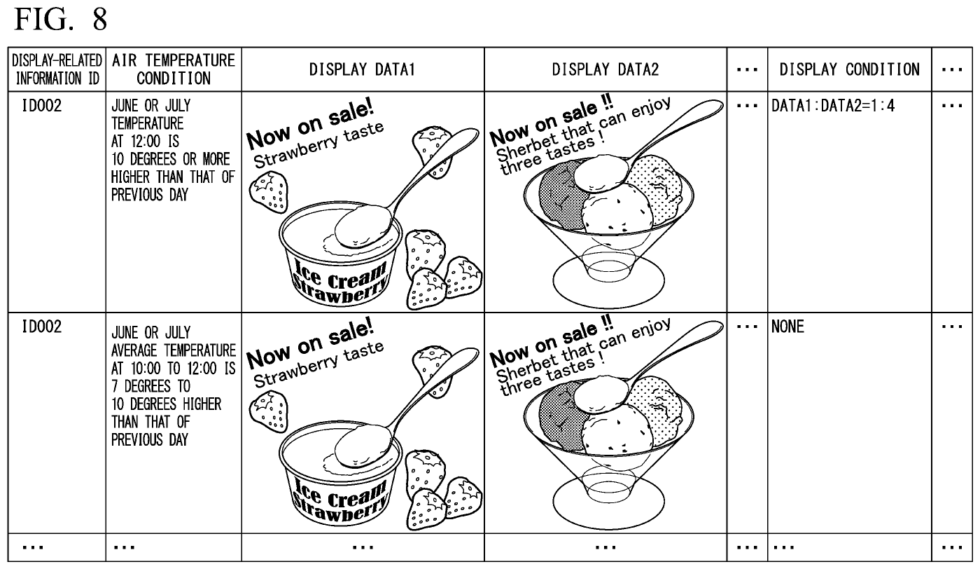

The display-related information storage unit 122b stores display-related information in which display information to be displayed on the display unit 11, an air temperature condition that is a condition related to an air temperature difference from a previous day for displaying the display information, and a display condition of the display information are associated with each other. The display condition of the display information includes a condition related to a time at which the display information is displayed, and a condition such as a display order of a plurality of pieces of the display information when the display information is configured from a plurality of images or videos. The display-related information storage unit 122b stores, for example, display-related information as shown in FIG. 8.

FIG. 8 is a diagram which shows an example of display-related information stored by the display-related information storage unit 122b.

The display-related information storage unit 122b stores the “display-related information ID,” the “air temperature difference condition,” a plurality of pieces “display data,” and the “display condition” in association with each other. When the “display data” is configured from a plurality of images or videos, the display-related information storage unit 122b stores each of them as “display data 1,” “display data 2,” and so forth. The “display condition” is a condition for displaying display information.

In the example shown in FIG. 8, for example, the “air temperature condition” corresponding to the “display-related information ID” of “ID002” is “June or July” and “the temperature at 12:00 is +7 to +10 degrees,” the “display data 1” is “a video related to a new release of strawberry-flavored ice cream,” the “display data 2” is “a video related to a newly released sherbet,” and the “display condition” is “display data 1:display data 2=1:4,” which indicates that the display data 2 is displayed for four times as long as the display data 1.

Note that if there are a plurality of pieces of “display data” and there is no “display condition,” it indicates that the plurality of pieces of “display data” will be evenly displayed. For example, display-related information whose “display-related information ID” is identified by “ID003” has two pieces of “display data,” but since the “display condition” is “none,” that is, since there is no condition, this indicates that the two pieces of the display data are displayed on the display unit 11 at the same time.

The acquisition schedule storage unit 123 stores information on a schedule for acquiring a temperature from the temperature detection unit 14 to be described below. The acquisition schedule storage unit 123 stores, for example, information on a time for acquiring air temperature information required to determine an air temperature condition of display-related information stored in the display-related information storage unit 122b.

The conversion information storage unit 124 stores conversion information for converting a temperature detected by the temperature detection unit 14 to be described below into an air temperature of the place in which the display device 1 is installed.

The temperature detected by the temperature detection unit 14 deviates from an actual air temperature when there is a heat source or the like in the vicinity of the temperature detection unit. Therefore, the conversion information storage unit 124 stores, for example, conversion information such as a conversion coefficient for converting the temperature detected by the temperature detection unit 14 into an air temperature, and a conversion table which shows a corresponding relationship between the temperature detected by the temperature detection unit 14 and the air temperature.

The processing unit 13b is a processor including a CPU and the like, and performs comprehensive control processing on the display device 1b. The processing unit 13b includes a display processing unit 131b and an air temperature information acquisition unit 132.

The display processing unit 131b performs display processing of determining display information based on air temperature information and display-related information and causing the display unit 11 to display the display information. A basic function of the display processing unit 131b is the same as that of the display processing unit 131a. When the display information is displayed, the display processing unit 131b causes the display unit 11 to display the display information on the basis of a display condition included in the display-related information.

The air temperature information acquisition unit 132 acquires the temperature detected by the temperature detection unit 14 to be described below and converts it into an air temperature. The air temperature information acquisition unit 132 acquires information on a date and time when the temperature detected by the temperature detection unit 14 is acquired from the acquisition schedule storage unit 123. The air temperature information acquisition unit 132 acquires the temperature detected by the temperature detection unit 14 on the acquisition date and time. The air temperature information acquisition unit 132 reads the conversion information from the conversion information storage unit 124 and converts the temperature acquired from the temperature detection unit 14 into an air temperature. The air temperature information acquisition unit 132 causes the air temperature information storage unit 121b to store the converted air temperature and the acquisition date and time information in association with each other.

The temperature detection unit 14 includes, for example, a temperature sensor such as a thermistor and a communication unit. The temperature sensor is installed, for example, on an outside of the display device 1b, in an intake port or an exhaust port of the display device 1b, in the vicinity of the display unit 11, or the like, and detects a temperature of a place where it is installed. The communication unit receives information for reading acquisition of a temperature from the air temperature information acquisition unit 132, and transmits information indicating a temperature detected by the temperature sensor to the air temperature information acquisition unit 132.

Next, an operation of the display device 1b according to the present embodiment will be described with reference to the drawings.

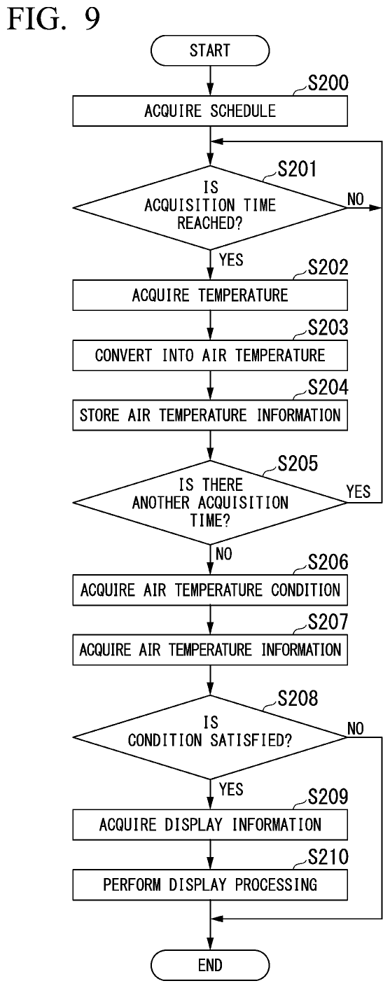

FIG. 9 is a flowchart which shows an example of processing of the display device 1b according to the present embodiment.

(Step S200) First, the processing unit 13b performs an air temperature information acquisition processing. The air temperature information acquisition unit 132 of the processing unit 13b reads a schedule for acquiring an air temperature from the acquisition schedule storage unit 123. The air temperature information acquisition unit 132 acquires information on a date and time for acquiring the air temperature from the read schedule, and the processing proceeds to step S201.

(Step S201) The air temperature information acquisition unit 132 acquires a current time and determines whether the current time has reached the date and time for acquiring a temperature. The air temperature information acquisition unit 132 determines that the acquisition time has arrived (step S201: YES) when the current time has reached the date and time for acquiring a temperature, and the processing proceeds to step S202. When the current time has not reached the date and time for acquiring a temperature, the air temperature information acquisition unit 132 determines that the acquisition time has not come (step S201: NO), and waits until the date and time for acquiring the air temperature, which is the date and time acquired from the acquisition schedule storage unit 123.

(Step S202) When the current time has reached the date and time for acquiring a temperature, the air temperature information acquisition unit 132 acquires a temperature detected by the temperature detection unit 14, and the processing proceeds to step S203.

(Step S203) The air temperature information acquisition unit 132 reads conversion information from the conversion information storage unit 124, and converts the acquired temperature into an air temperature on the basis of the acquired temperature and the conversion information. When the conversion information is a conversion coefficient, the air temperature information acquisition unit 132 converts the acquired temperature into an air temperature by using the conversion coefficient. When the conversion information is a conversion table, the air temperature information acquisition unit 132 converts the acquired temperature into an air temperature on the basis of the acquired air temperature and the conversion table. When the air temperature information acquisition unit 132 ends the processing described above, the processing proceeds to step S204.

(Step S204) The air temperature information acquisition unit 132 causes the air temperature information storage unit 121b to store air temperature information in which an acquisition date and time and an air temperature on the acquisition date and time are associated with each other, and the processing proceeds to step S205.

(Step S205) The air temperature information acquisition unit 132 refers to a schedule acquired from the acquisition schedule storage unit 123, and determines whether there are other dates and times for acquiring air temperatures. The air temperature information acquisition unit 132 determines that it is necessary to further acquire an air temperature when there are other dates and times for acquiring it (step S205: YES), returns to step S101, and acquires air temperature information on the other dates and times. The air temperature information acquisition unit 132 determines that it is not necessary to acquire an air temperature when there is no other dates and times for acquiring it (step S205: NO), ends air temperature information acquisition processing, and the processing unit 13b advances the processing to step S206.

(Step S206) The display processing unit 131b subsequently performs display processing. First, the display processing unit 131b reads the display-related information from the display-related information storage unit 122b, acquires conditions required to determine an air temperature difference condition, and the processing proceeds to step S207. Since processing of step S206 is the same as that of step S100 in the second embodiment, the description thereof will be omitted.

(Step S207) The display processing unit 131b acquires air temperature information from the air temperature information storage unit 121b on the basis of the conditions required to determine the air temperature difference condition. When the display processing unit 131b acquires the air temperature information, the processing proceeds to step S208. Since processing of step S207 is the same as that of step S101 in the second embodiment, the description thereof will be omitted.

(Step S208) The display processing unit 131b obtains the air temperature difference on the basis of the acquired air temperature information, and determines whether the air temperature difference condition is satisfied. Since processing of step S208 is the same as that of step S102 in the second embodiment, the description thereof will be omitted. When the display processing unit 131b determines that the air temperature difference condition is satisfied (step S208: YES), the processing proceeds to step S209.

(Step S209) The display processing unit 131b refers to the display-related information, and acquires a display condition and display information of the display-related information satisfying the air temperature condition, and the processing proceeds to step S210.

(Step S210) The display processing unit 131b causes the display unit 11 to display the display information on the basis of the acquired display conditions, and ends the display processing.

Next, an example of the present invention will be described with reference to FIGS. 7 and 8. In this example, the display device 1b is installed in a storefront of a supermarket. In addition, an example in which a day to be described is June 2^{nd} will be described.

The air temperature information acquisition unit 132 acquires an acquisition schedule, and acquires air temperature information as shown in FIG. 7 on the basis of the acquired schedule. For example, the acquisition schedule describes that air temperatures at 10 o'clock, 11 o'clock, and 12 o'clock are acquired.

The display processing unit 131b acquires display-related information from the display-related information storage unit 122b, and acquires the date and time condition for obtaining an air temperature difference from an air temperature condition included in the display-related information. In the example of FIG. 8, for example, for display-related information identified by “ID002,” it is acquired that “June or July” is the date and time condition. The display processing unit 131b acquires date and time information on a current day, and determines that the current day has satisfied the condition of “June or July.” Subsequently, the display processing unit 131b refers to the air temperature difference condition, and acquires information on air temperatures at 12:00 on June 1^{st} (a previous day) and June 2^{nd} (the current day) from the air temperature information storage unit 121b. In the example shown in FIG. 7, the acquired air temperatures are “17.0” degrees and “28.0” degrees. The display processing unit 131b obtains an air temperature difference on the basis of the acquired information. In this case, the air temperature difference is +11 degrees from the previous day. Since the air temperature condition is “10 degrees or higher as compared to that of the previous day,” the display processing unit 131b determines that the obtained air temperature difference satisfies the air temperature condition.

Since the air temperature condition, which is included in the display-related information identified by “ID002” is satisfied, the display processing unit 131b causes display information included in the display-related information to be displayed on the display unit 11. In this case, since a display ratio of the display data is indicated in a display condition, the display processing unit 131b causes the display unit 11 to perform a display such that a display time is the ratio indicated in the display condition.

On the other hand, for example, for display-related information identified by “ID003,” since the date and time condition for obtaining an air temperature difference is “June or July,” the display processing unit 131b determines that a current day has satisfied the date and time condition for obtaining an air temperature difference. The display processing unit 131b subsequently refers to the air temperature difference condition, and acquires information on air temperatures at 10:00, 11:00, and 12:00 on June 1^{st} (the previous day) and June 2^{nd} (the current day) required to obtain an air temperature difference from the air temperature information storage unit 121b. In the example shown in FIG. 6, the air temperatures on June 1^{st} are “15.0” degrees, “16.0” degrees, and “17.0” degrees, respectively, and the air temperatures on June 2^{nd} are “26.0” degrees, “27.0” degrees, and “28.0” degrees, respectively. The display processing unit 131b determines whether the air temperature difference condition is satisfied. First, the display processing unit 131b obtains an average air temperature of June 1^{st} and 2^{nd}. As shown in FIG. 7, the average air temperature of June 1^{st} is 16.0 degrees, and the average air temperature of June 2^{nd} is 27.0 degrees. Therefore, since a temperature difference of the average air temperatures is +11 degrees, the display processing unit 131b determines that the air temperature condition is not satisfied, and ends the processing without causing the display unit 11 to display the display information included in the display-related information identified by “ID003.”

Supermarket shoppers want to eat cold products such as ice on a sudden hot day, but prefer frozen desserts such as sorbet, which are even lower in milk fat than creams such as ice cream, on a hotter day. In the example described above, the display device 1b can easily display an advertisement of a product desired by a shopper who is a viewer without spending time or staff of a store by preparing the advertisement matching this tendency in advance.

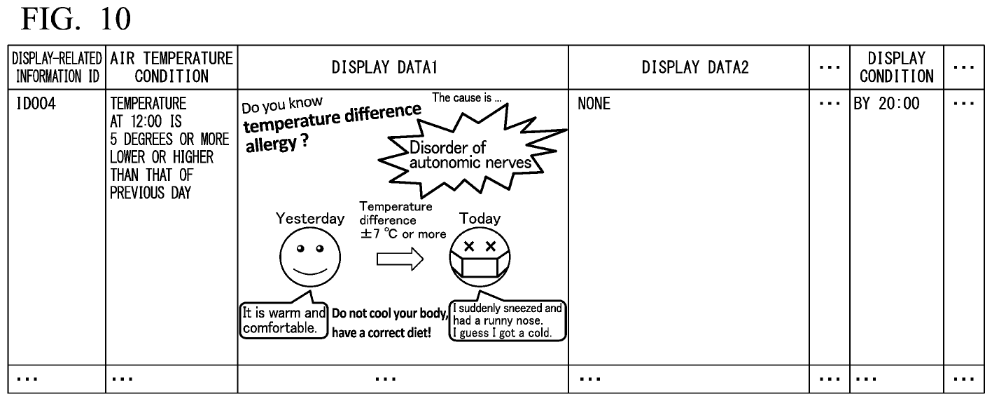

Next, another example of the present invention will be described with reference to FIGS. 7 and 10. The display device 1b is installed in a shared space of a hospital, which is open by 20:00 in the present example. In the present example, an example in which a day to be described is June 2^{nd} will be also described.

FIG. 10 is a diagram which shows another example of the display-related information storage unit 122b according to the present embodiment. In this case, in the example of FIG. 10, for example, display information included in display-related information whose display-related information ID is identified by “ID004” is displayed when a temperature at 12:00 is 5 degrees or more higher or lower than that of the previous day. Since the display-related information is not the condition for date and time, the display processing unit 131b does not determine on the condition for date and time, and subsequently acquires a condition for determining the air temperature difference condition. In the present example, since air temperature information of 12:00 on June 1^{st} and 12:00 on June 2^{nd} only needs to be obtained, the display processing unit 131b acquires air temperature information on a corresponding date and time from the air temperature information storage unit 121b. The display processing unit 131b obtains an air temperature difference on the basis of the acquired air temperature information. In this example, since the air temperature difference is +11 degrees, the display processing unit 131b determines that the air temperature condition is satisfied for the display-related information whose display-related information ID is identified by “ID004.” The display processing unit 131b acquires display information and display condition of the display-related information, and causes the display unit 11 to display the display information according to the display condition. In this example, as the display condition, it is shown that a display is performed by 20:00. The display processing unit 131b displays display information that calls attention to a damage in health, caused by a temperature difference, by 20:00 according to the display condition. In addition, the display processing unit 131b stops displaying the display information after 20:00.

In this manner, even for information that is useful to a target person who views the display device 1b but does not directly contribute to sales, or the like, by setting a display condition for the information in advance, it is possible to cause a person who views the display device 1b, such as a patient whose physical strength is weak or the like, to visually recognize effective information without spending time or human labor.

As described above, the display device 1b according to the present embodiment includes the display unit 11, the storage unit 12b that stores display-related information in which an air temperature condition, which is a condition for displaying display information to be displayed on the display unit 11 and is a condition related to an air temperature difference from a previous day, is associated with the display information, and air temperature information in which a date and time are associated with an air temperature on the date and time, the temperature detection unit 14 that detects a temperature, the air temperature information acquisition unit 132 that acquires air temperature information on the basis of a temperature detected by the temperature detection unit 14, and the display processing unit 131b that determines the display information to be displayed on the display unit 11 on the basis of the air temperature difference, obtained on the basis of first air temperature information that is the air temperature information on a day when the display unit 11 displays the display information and second air temperature information that is the air temperature information on a previous day of the day, and the display-related information, and causes the display unit 11 to display the determined display information.

As a result, the display device 1b according to the present embodiment can display information based on a temperature difference according to a timing that is useful to a viewer on the basis of, for example, air temperature information acquired on the basis of a temperature detected by the temperature detection unit. Therefore, the display device 1b according to the present embodiment can easily present information according to a temperature difference.

Moreover, in the present embodiment, the display-related information further includes a time condition related to a time for displaying the display information, and the display processing unit 131b displays the display information on the display unit 11 based on the time condition.

As a result, the display device 1b according to the present embodiment can easily present information according to a temperature difference at an appropriate timing without spending manpower and time by setting in advance display information at a time at which the display information can be visually recognized most effectively.

In addition, advertisement information is displayed as display information in the present embodiment.

As a result, the display device 1b according to the present embodiment can easily present effective advertisement information at a timing appropriate for an advertisement without spending manpower and time when a specific air temperature difference occurs.

As described above, although the embodiments of the present invention have been described with reference to the drawings, a specific configuration is not limited to the embodiments described above, and includes designs and the like within a range not departing from the gist of the present invention.

For example, the temperature detection unit 14 may be separately installed outdoors when the display device 1b is installed indoors. In this case, the air temperature information acquisition unit 132 may set a temperature acquired by the temperature detection unit 14 as air temperature and cause air temperature information to be stored in the air temperature information storage unit 121b.

In addition, the display device 1b may include a communication unit, and the air temperature information acquisition unit 132 may acquire the air temperature information from a network via the communication unit. The communication unit connects to the network using a wired local area network (LAN) communication, a wireless LAN communication, or the like, and receives the air temperature information from a storage unit on the network.

Further, the storage unit 12 (12a, 12b) included in a display device 1 (1a, 1b) may be provided outside the display device 1 (1a, 1b). In this case, the display device 1 (1a, 1b) may be, for example, a projector, and receive information to be displayed from a device including a storage unit 12 (12a, 12b) included externally, and project the received information.

In addition, the display device 1b may further include a humidity temperature detection unit and a wind speed detection unit for detecting relative humidity and wind speed, and the air temperature information acquisition unit 132 may calculate a sensible temperature using humidity, wind speed, and an air temperature. In this case, the display processing unit 131b may determine an air temperature condition according to the sensible temperature.

Moreover, when the display processing unit 131 (131a, 131b) determines whether the air temperature condition is satisfied, it is first determined whether the air temperature difference satisfies the date and time condition and then it is determined whether the air temperature difference satisfies the air temperature difference condition in the description above, but the order may be reversed. That is, it may be determined whether the air temperature difference satisfies the air temperature difference condition first, and then it may be determined whether the air temperature difference satisfies the date and time condition.

Moreover, construction management may be performed by recording a program for realizing functions of the processing unit in FIGS. 1, 2 and 6 in a computer-readable recording medium, and causing a computer system to read and execute the program recorded in the recording medium. The “computer system” herein includes hardware such as peripheral devices and an OS.

The “computer-readable recording medium” refers to a portable medium such as a flexible disk, a magneto-optical disc, a ROM, or a CD-ROM, or a storage device such as a hard disk embedded in a computer system. Furthermore, the “computer-readable recording medium” may include a medium that dynamically holds a program for a short period of time, such as a communication line when a program is transmitted via a network such as the Internet or a communication line such as a telephone line, and a medium that holds the program for a certain period of time, such as a volatile memory inside a computer system that serves as a server or client in this case. Moreover, the program described above may be a program for realizing a part of the functions described above, and may further be a program that can realize the functions described above in combination with a program already recorded in the computer system.

In addition, a part or all of the display device 1 in the embodiments described above may be realized as an integrated circuit such as a Large Scale Integration (LSI). Each functional unit of the display device 1 may be made to be a processor individually, and a part or all of them may be integrated to be a processor. Moreover, a method of making an integrated circuit is not limited to the LSI, and may be realized by a dedicated circuit or a general-purpose processor. Furthermore, when a technology of making an integrated circuit, which replaces the LSI with, has appeared due to advances in semiconductor technology, an integrated circuit according to this technology may be used.

### REFERENCE SIGNS LIST

1, 1a, 1b Display device
11 Display unit
12, 12a, 12b Storage unit
13, 13b Processing unit
14 Temperature detection unit
121, 121b Air temperature information storage unit
122, 122b Display-related information storage unit
123 Acquisition schedule storage unit
124 Conversion information storage unit
131, 131a, 131b Display processing unit
132, 132b Air temperature information acquisition unit

What is claimed is:

1. A display device comprising:
a display unit;
a storage unit that stores display-related information in which an air temperature condition, which is a condition for displaying display information to be displayed on the display unit and is a condition related to an air temperature difference from a previous day, is associated with the display information, and stores air temperature information in which a date and time are associated with an air temperature on the date and time; and
a display processing unit configured to determine the display information to be displayed on the display unit on the basis of the air temperature difference obtained on the basis of a first air temperature information that is the air temperature information on a day when the display unit displays the display information and a second air temperature information that is the air temperature information on a previous day of the day, and the display-related information, and cause the display unit to display the determined display information.

2. The display device according to claim 1, further comprising:
a temperature detection unit configured to detect a temperature and an air temperature information acquisition unit configured to acquire the air temperature information,
wherein the air temperature information acquisition unit acquires the air temperature on the basis of a temperature detected by the temperature detection unit.

3. The display device according to claim 1,
wherein the display-related information further includes a time condition related to a time at which the display information is displayed, and
the display processing unit is configured to display the display information on the display unit on the basis of the time condition.

4. The display device according to claim 1,
wherein the display information is an advertisement information on an advertisement.

5. A display method of a display device that includes a display unit, a storage unit configured to store display-related information in which an air temperature condition, which is a condition for displaying display information to be displayed on the display unit and is a condition related to an air temperature difference from a previous day, is associated with the display information, and air temperature information in which a date and time are associated with an air temperature on the date and time, the display method comprising:
determining, by a display processing unit, the display information to be displayed on the display unit on the basis of the air temperature difference obtained on the basis of first air temperature information that is the air temperature information on a day when the display unit displays the display information and second air temperature information that is the air temperature information on a previous day of the day, and the display-related information, and causing the display unit to display the determined display information.

6. A non-transitory computer readable storage medium that stores a display program that causes a computer of a display device, which includes a display unit, and a storage unit configured to store display-related information in which an air temperature condition, which is a condition for displaying display information to be displayed on the display unit and is a condition related to an air temperature difference from a previous day, is associated with the display information, and air temperature information in which a date and time are associated with an air temperature on the date and time, to execute processing of
determining the display information to be displayed on the display unit on the basis of the air temperature difference, obtained on the basis of first air temperature information that is the air temperature information on a day when the display unit displays the display information and second air temperature information that is the air temperature information on a previous day of the day, and the display-related information, and causing the display unit to display the determined display information.
